(19) United States
(12) Patent Application Publication
(10) Pub. No.: US 2025/0327481 A1
(43) Pub. Date: Oct. 23, 2025

(54) A TANDEM BALL BEARING

(71) Applicant: NATIONAL ENGINEERING INDUSTRIES LTD., JAIPUR (RAJASTHAN) (IN)

(72) Inventors: Vimlesh Jayantilal PATEL, Kadi (Gujarat) (IN); Gurkirat SINGH, Jaipur (Rajasthan) (IN); Raj Kumar SINGHAL, Jaipur (Rajasthan) (IN); Kailash Chand AJMERA, Jaipur (Rajasthan) (IN)

(73) Assignee: NATIONAL ENGINEERING INDUSTRIES LTD., JAIPUR (RAJASTHAN) (IN)

(21) Appl. No.: 18/855,294

(22) PCT Filed: Apr. 5, 2023
(86) PCT No.: PCT/IB2023/053471

§ 371 Date: Oct. 8, 2024

(30) Foreign Application Priority Data
Apr. 8, 2022 (IN) 202211021165

(51) Int. Cl. F16C 19/18; F16C 19/50

(52) U.S. Cl. CPC F16C 19/182; F16C 19/505; F16C 2361/61

(57) ABSTRACT

The present invention provides a tandem ball bearing (38). A tandem ball bearing (38) includes an outer ring (36) and an inner ring (34). The tandem ball bearing (38) includes a plurality of outer balls (37) disposed between the outer ring (36) and the inner ring (34) to form an outer ball row (2). The tandem ball bearing (38) includes a plurality of inner balls (35) disposed between the outer ring (36) and the inner ring (34) to form an inner ball row (4). The plurality of outer balls (37) and the plurality of inner balls (35) are configured such that a plurality of external tangent apex (10) (12) (14) (16) associated with the plurality of outer balls (37) and the plurality inner balls (35) meet at a common point (18) on a bearing central axis (20).

### CROSS-REFERENCE TO RELATED APPLICATIONS

This application is a national stage application under 35 U.S.C. § 371 of PCT patent application PCT/IB2023/053471 filed on 5 Apr. 2023, which is pending and which is hereby incorporated by reference in its entirety for all purposes. PCT patent application PCT/IB2023/053471 claims priority to Indian patent application IN 202211021165 filed 8 Apr. 2022, which is hereby incorporated by reference in its entirety for all purposes.

### TECHNICAL FIELD

The present invention generally relates to field of a bearing. More particularly, the invention relates to a tandem ball bearing.

### BACKGROUND OF THE INVENTION

Various taper roller bearings are well known as a roller bearing element. The normal design consists of an inner ring, an outer ring, rollers and a cage. The purpose of the cage may be to guide the rollers and retain them in place. These tapered roller bearings are formed at high axial forces occurring with a large pressure angle and ensure high rigidity of the supported shaft. However, since tapered-roller bearings experience sliding friction between an end surface of the tapered rollers and a guide surface of a bearing rim of the tandem bearing on account of their preload, with the result of which sliding friction wear occurs on the tapered rollers and on the bearing rim, it has been proposed in DE19839481A1.

Tandem bearings consist of several axial cylindrical roller bearings (balls or cylinders) arranged in a line for carrying high value loads and length wise bearing applications. Tandem bearings are widely used in gearboxes.

Tandem ball bearings proposed with the DE102005029983A1, shown that a common axis of rotation of each adjacent ball rollers of both rows of the tandem balls are arranged in a common cage. The pocket ball rollers may be lost under certain load conditions, with the result that between the mutually facing side surfaces of each adjacent ball rollers different rotational speeds friction arises. If these unfavourable load conditions occur more frequently or at short intervals, this friction between the ball rollers causes a considerable increase in temperature in the bearing, which can lead to the breakage of the rolling contact and eventually also lead to failure of the ball bearing. In addition, the ball rollers tend under highly dynamic load changes to increased wobble and rolling movements, as a result of which there may be an increased friction on the bearing cage and accompanied by the cage wear.

Further, in the presently existing tandem bearings, the probability/occurrence of slipping motion between the rolling elements of bearing or any such relative motions apart from desired rolling motion is more. This results in pure rolling motion of the bearing elements being under/less achieved. Further, internal dynamics of existing tandem bearings are not satisfactory. Internal dynamics may be defined as the dynamic uncontrolled motions of bearing elements in bearing.

Accordingly, there remains the need for a tandem ball bearing arrangement, which results in better frictional behaviour and a product solution for the replacement of taper roller bearing that obviates the aforesaid drawbacks.

### OBJECT AND SUMMARY OF THE INVENTION

An object of the present invention is to provide a tandem ball bearing (38). The tandem ball bearing (38) includes an outer ring (36); and an inner ring (34). The tandem ball bearing (38) includes a plurality of outer balls (37) disposed between the outer ring (36) and the inner ring (34) to form an outer ball row (2). The tandem ball bearing (38) includes a plurality of inner balls (35) disposed between the outer ring (36) and the inner ring (34) to form an inner ball row (4). The plurality of outer balls (37) and the plurality of inner balls (35) are configured such that a plurality of external tangent apex (10) (12) (14) (16) associated with the plurality of outer balls (37) and the plurality inner balls (35) meet at a common point (18) on a bearing central axis (20).

Another object of the present invention is to provide a tandem ball bearing (38). A tandem ball bearing (38) includes an outer ring (36) and an inner ring (34). The tandem ball bearing (38) includes a plurality of outer balls (37) disposed between the outer ring (36) and the inner ring (34) to form an outer ball row (2). The tandem ball bearing (38) includes a plurality of inner balls (35) disposed between the outer ring (36) and the inner ring (34) to form an inner ball row (4). The plurality of outer balls (37) and the plurality of inner balls (35) are configured such that a plurality of external tangent apex (10) (12) (14) (16) associated with the plurality of outer balls (37) and the plurality inner balls (35) meet at a common point (18) on a bearing central axis (20). A plurality of outer balls is disposed between the outer ring (36) and the inner ring (34) forming the outer ball row (2) have a first ball diameter (28). A plurality of inner balls is (is) disposed between the outer ring (36) and the inner ring (34) forming the inner ball row (4) have a second ball diameter (32).

In another object of the present invention, the tandem ball bearing (38) includes the outer ball row (2) having an outer pitch diameter (67) and the inner ball row (4) having an inner pitch diameter (69). The ratio of the outer pitch diameter (67) and the inner pitch diameter (69) may be given by an equation which is (67)/(69)=(28)/(32).

### BRIEF DESCRIPTION OF THE DRAWINGS

The embodiments of the invention are illustrated in the accompanying drawings, throughout which the reference letters indicate corresponding part in the various figures. The embodiments herein will be better understood from the following description with reference to the drawings, in which:

FIG. 1 illustrates a sectional view of a tandem ball bearing, in accordance with an embodiment of the present invention;

FIG. 2 illustrates a sectional view of a tandem ball bearing with regard to the additional parameters, in accordance with an embodiment of the present invention;

FIG. 3 illustrates a sectional view of a tandem ball bearing, in accordance to another embodiment of the present invention; and

FIG. 4 illustrates a sectional view of a tandem ball bearing, in accordance to yet another embodiment of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In the specification and the claims which follow, reference will be made to a number of terms which shall be defined to have the following meanings:

The singular forms “a”, “an” and “the” include plural referents unless the context clearly dictates otherwise. “Optional” or “optionally” means that the subsequently described event or circumstance may or may not occur, and that the description includes instances where the event occurs and instances where it does not. “Substantially” means a range of values that is known in the art to refer to a range of values that are close to, but not necessarily equal to a certain value.

Other than in the examples or where otherwise indicated, all numbers or expressions referring to quantities of ingredients, reaction conditions, and the like, used in the specification and claims are to be understood as modified in all instances by the term “about.” In some aspects of the current disclosure, the terms “about” or “approximately” are defined as being close to as understood by one of ordinary skill in the art, and in one non-limiting embodiment the terms are defined to be within 10%, alternatively within 5%, alternatively within 1%, or alternatively within 0.5%.

Various numerical ranges are disclosed herein. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The endpoints of all ranges directed to the same component or property are inclusive of the endpoint and independently combinable. The term “from more than 0 to an amount” means that the named component is present in some amount more than 0, and up to and including the higher named amount.

As used herein, “combinations thereof” is inclusive of one or more of the recited elements, optionally together with a like element not recited, e.g., inclusive of a combination of one or more of the named components, optionally with one or more other components not specifically named that have essentially the same function. As used herein, the term “combination” is inclusive of blends, mixtures, alloys, reaction products, and the like.

As used herein, the term “substantially” and its variations are defined as being largely but not necessarily wholly what is specified as understood by one of ordinary skill in the art, and in one non-limiting aspect substantially refers to ranges within 10%, within 5%, within 1%, or within 0.5%.

An embodiment of the present invention is to provide a tandem ball bearing (38). The tandem ball bearing (38) includes an outer ring (36) and an inner ring (34). A plurality of outer balls (37) is disposed between the outer ring (36) and the inner ring (34) to form an outer ball row (2) with. A plurality of inner balls (35) is disposed between the outer ring (36) and the inner ring (34) to form an inner ball row (4). The plurality of outer balls (37) and the plurality of inner balls (35) are configured such that a plurality of external tangent apex (10) (12) (14) (16) associated with the plurality of outer balls (37) and the plurality inner balls (35) meet at a common point (18) on a bearing central axis (20).

In another embodiment of the present invention, a tandem ball bearing (38) is provided. The tandem ball bearing (38) includes an outer ring (36) and an inner ring (34). A plurality of outer balls is disposed between the outer ring (36) and the inner ring (34) to form an outer ball row (2). The outer ball row (2) has an outer pitch diameter 67. Each (62) of the plurality of outer balls (37) has a diameter (28). In another embodiment of the present invention the plurality of inner balls (35) are disposed between the outer ring (36) and the inner ring (34) to form an inner ball row (4). The inner ball row (4) has an inner pitch diameter (69). Each (63) of the plurality of inner balls (35) has a diameter (32).

In one embodiment of the present invention, the outer ring (36) may include an outer pocket (61) configured to accommodate the plurality of outer balls (37) and the plurality of inner balls (35). In another embodiment of the present invention, the inner ring (34) may include an inner pocket (65) configured to accommodate the plurality of outer balls (37) and the plurality of inner balls (35). In yet another embodiment of the present invention, the outer ring (36) and the inner ring (34) may configure a cage (39) to facilitate individual rolling motion of each outer ball (62) and each inner ball (63). In yet another embodiment of the present invention, the diameter (28) of outer balls (28) is greater than the diameter (32) of inner balls (28).

In an embodiment of the present invention, the outer ring (36) and the inner ring (34) are configured to accommodate the outer balls (37) and the inner balls (35) such that, a plurality of external tangent apex (10) (12) (14) (16) associated with the plurality of outer balls (37) and the plurality inner balls (35) meet at a common point (18) on a bearing central axis (20). The bearing central axis (20) is an axis of all coaxial rotating members of the bearing (38). The rotating members can be the inner ring (34) and the outer ring (36) or any such rotating elements of the tandem ball bearing (38).

The geometric dimensions of the outer balls (37), the inner balls (35), the outer pockets (61), the inner pockets (65), an outer raceway (6) and an inner raceway (8) are configured to meet the plurality of external tangent apex (10) (12) (14) (16) a common point (18) on a bearing central axis (20). A person skilled in the art can configure (decide) the geometric of the outer balls (37), the inner balls (35), the outer pockets (61), the inner pockets (65), the outer raceway (6) and the inner raceway (8) in a design phase of making a tandem ball bearing (38) and check whether the plurality of external tangent apex (10) (12) (14) (16) are meeting at a common point (18) on a bearing central axis (20) of the tandem ball bearing (38) or not. And then further proceeded to make each components accordingly and then assemble the components to make the tandem ball bearing (38) in accordance with the present invention.

For example, a person skilled in the art by using a simulation software or a CAM (Computer aided Modelling) tool, can design the geometric of the outer balls (37) with diameter “X” units, the inner balls (35) with diameter of “Y” units. The prior art existing CAM (Computer aided Modelling) tools are already featured to analyse the tangency between the component's. Therefore, by using the tools, the person can check whether the plurality of external tangent apex (10) (12) (14) (16) are meeting at a common point (18) on a bearing central axis (20) of the tandem ball bearing (38) or not. If the tangents (10) (12) (14) (16) are meeting, a tandem ball bearing (38) can be made with the outer balls (37) with diameter “X” units, the inner balls (35) with diameter of “Y” units.

In one more embodiment, a person skilled in the art can set positions of the inner row (4) and the outer row (2) for the plurality of external tangent apex (10) (12) (14) (16) to meet at a common point (18) on a bearing central axis (20) of the tandem ball bearing (38). In one embodiment of the present invention, the positions (each position) of the inner row (4) and the outer row (2) can be in an axial position from a fixed reference (not numbered). In one embodiment of the present invention, the fixed reference can be any face or a relatively non-moving position of the tandem ball bearing (38, 40).

The tandem ball bearing (38) (40) in accordance with one embodiment of the present invention will now be described with reference to the drawings.

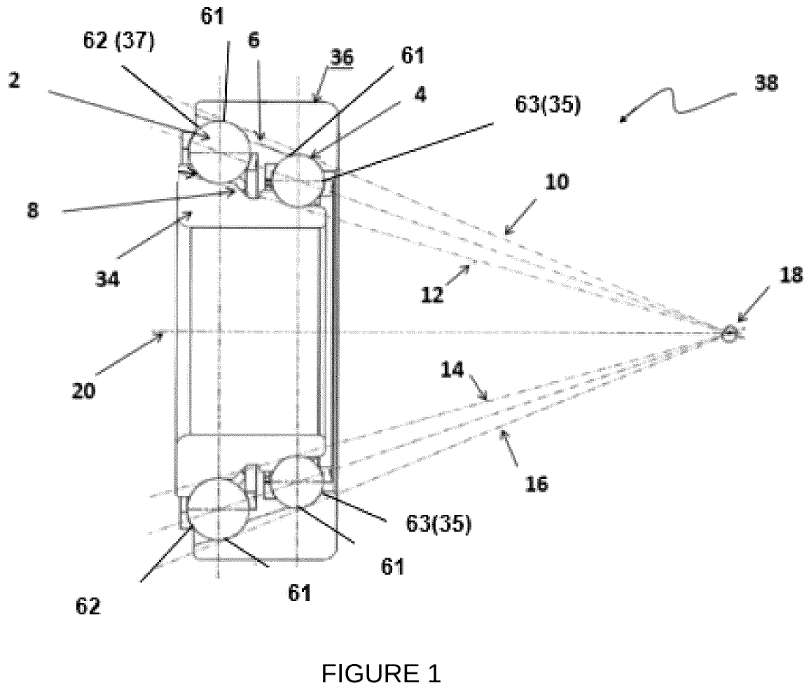

As shown FIG. 1 depicts, a sectional view of the tandem ball bearing (38) in accordance with an embodiment of the present invention. As shown in the example embodiment of FIG. 1, the tandem ball bearing (38) includes the outer ring (36) and the inner ring (34). The plurality of outer balls is disposed between the outer ring (36) and the inner ring (34) to form the outer ball row (2). The plurality of inner balls is disposed between the outer ring (36) and the inner ring (34) to form an inner ball row (4). Further, the tandem ball bearing (38) can includes an outer raceway geometry (6) and an inner raceway geometry (8). In one embodiment of the present invention, the outer raceway geometry (6) and the inner raceway geometry (8) guides the outer ball row (2) and the inner ball row (4).

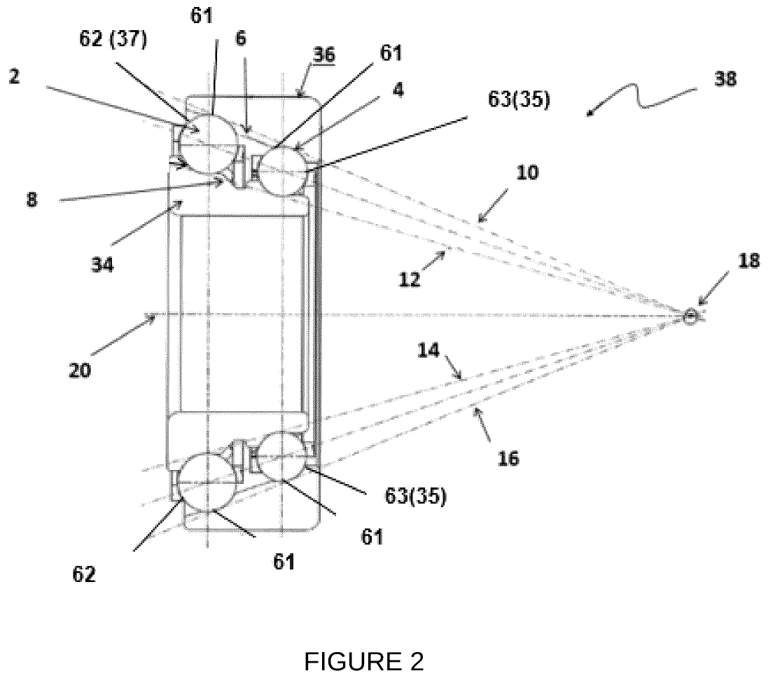

In FIG. 2, a sectional view of the tandem ball bearing (40) in accordance with an embodiment of the present invention is shown. The tandem ball bearing (40) includes the outer ball row (2) and inner ball row (4). The outer ball row (2) has a first ball diameter (28) and the inner ball row (4) has a second ball diameter (32). Generally, in the ball bearing, a diameter of a ball may be any straight line segment that passes through a centre of the ball and whose end points lie on the ball.

In another embodiment of the present invention, the first ball diameter (28) may be greater than the second ball diameter (32). In yet another embodiment of the present invention, the tandem ball bearing (40) includes the outer ball row (2) has an outer pitch diameter 67 and the inner ball row (4) has an inner pitch diameter (69). As known to one skilled in the art, the bearing pitch diameter may be defined as the diameter of a ball that the centre point of the ball travels during rotation of the bearing. In yet another embodiment of the present invention, the ratio of the outer pitch diameter (67) and the inner pitch diameter (69) may be given by such as given in Equation 1 wherein (67)/(69)=(28)/(32) (Equation 1).

In an example embodiment of the present invention, the ratio of the outer pitch diameter (67) to the inner pitch diameter (69) is equal to ratio of the diameter of each of the plurality of outer balls (28) to the diameter of each of the plurality of inner balls (32). For example, the tandem ball bearing (38, 40) can be configured with an outer ball (62) having diameter (28) of 8 millimetre and an inner ball (63) having diameter (32) of 4 millimetre, the outer pitch diameter (67) of 64 millimetre and the inner pitch diameter (69) of 32 millimetre. When the geometrics of the elements (62, 63) are configured and positioned according to the ratio, the plurality of external tangent apex (10) (12) (14) (16) meet at the common point (18).

Further, in FIG. 2 shows the sectional view of the tandem ball bearing (40) in accordance with an embodiment of the present invention. The tandem ball bearing (40) includes the outer ring (36) with a minimum section outer ring (26). Further, the tandem ball bearing (40) includes the inner ring (34) with a minimum section inner ring (30). The minimum section of the inner ring (30) is a radial sectional distance of the inner ring (34) from an internal diameter (74) of the inner ring (34) to the inner pocket (65).

In one embodiment of the present invention, the value of the minimum section outer ring (26) may be at greater than or equal to 0.15 times of the outer ball diameter (28). Similarly, the value of the minimum section of the inner ring (30) may be greater than or equal to 0.15 times of the inner ball diameter (32). The minimum section of the outer ring (26) is a radial sectional distance of the outer ring (36) from an internal outer ring diameter (73) of the outer ring (36) to the outer pocket (61).

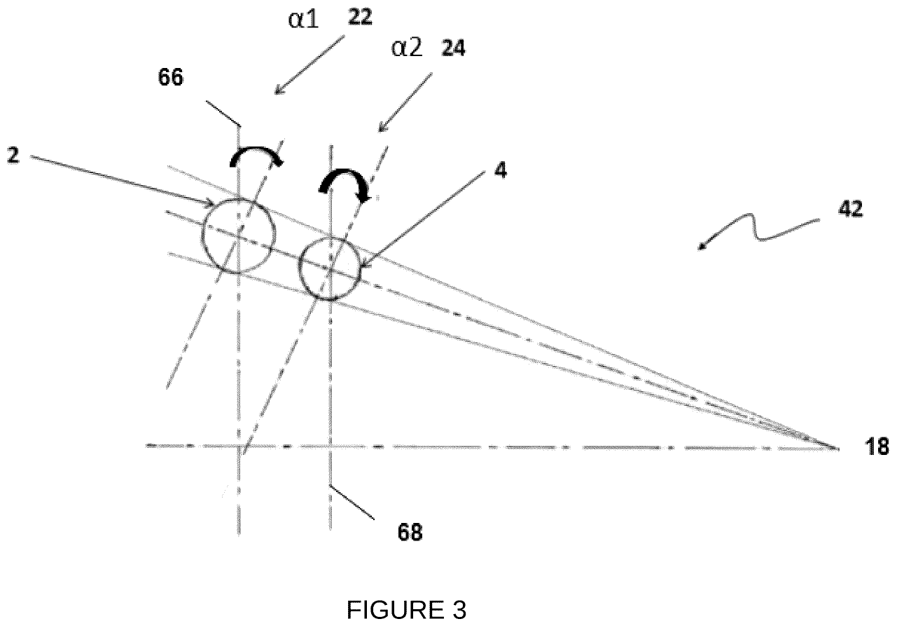

As shown in FIG. 3, a sectional view of a tandem ball bearing (42) in accordance with an embodiment of the present invention. The tandem ball bearing includes the outer ball row (2) and the inner ball row (4). The outer ring (36) and the inner ring (34) accommodates the outer ball row (2) having a contact angle α1 (22) and the inner ball row (4) having a contact angle α2 (24). As known to one skilled in the art, “the contact angle” may be defined as a line passing through the points of contact of each ball (62, 63) with the outer raceway (6) and the inner raceway (8). The outer raceway (6) and the inner raceway (8) may be inclined by an angle α (herein after also referred to as “contact angle”) with respect to a plane passing through the centre of a first ball (62) and the centre of a second ball (63) located in a position diametrically opposite the first. In another embodiment of the present invention, the contact angle α1 (22) and α2 (24) may be similar (same/equal) (α1=α2).

In an example embodiment of the invention, the outer ring (36) and the inner ring (34) accommodates the outer ball row (2) and the inner ball row (4) with the contact angle α1 (22) equal to the contact angle α2 (24). For example, the outer ring (36) and the inner ring (34) holds the outer ball row (2) and the inner ball row (4) with the contact angle α1 (22) equal to 35 degrees from an outer vertical line (66) in a clock wise direction. The contact angle α2 (24) equal to 35 degrees from an inner vertical line (68) in a clock wise direction. When the outer ring (36) and the inner ring (34) holds the outer ball row (2) and the inner ball row (4) with equal contact angles (α1=α2), the plurality of external tangent apex (10) (12) (14) (16) meet at the common point (18).

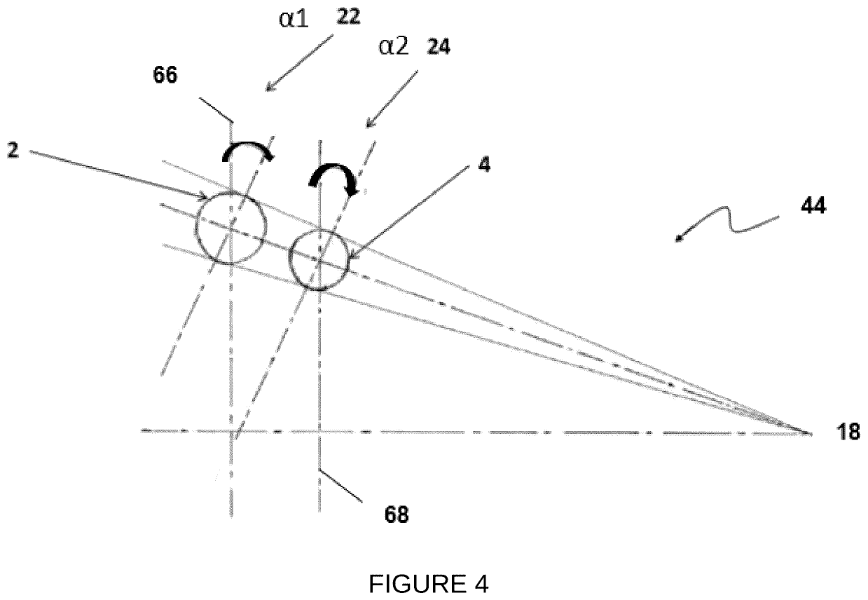

A sectional view of a tandem ball bearing (44) in accordance with an embodiment of the present invention is shown in FIG. 4. The tandem ball bearing (44) includes the outer ball row (2) and the inner ball row (4). In one embodiment of the present invention, the outer ball row (2) includes a contact angle α1 (22) and the inner ball row (4) includes a contact angle α2 (24). In another embodiment of the present invention, the contact angle α1 (22) and α2 (24) may not be similar (α1/α2). In yet another embodiment of the present invention, a difference between the contact angle α1 and the contact angle α2 has at least ≤5 degree. Further, the difference between the contact angle (α1−α2)≤5 degree would ensure the condition of pure rolling motion. In the above example embodiment of the present invention, the plurality of external tangent apex (10) (12) (14) (16) will substantially meet at the common point (18).

The tandem ball bearing (38) of the present invention may be used in many applications. The application includes but is not limited to automotive industry and industries which employs the use of bearings. In another embodiment of the present invention, the tandem ball bearing (38, 40, 42, 44) can be used in gearboxes of automobiles.

### Advantages

The technical advantages brought in by the present invention are as follows: 1. Pure rolling motion. 2. Better frictional behaviour. 3. Better internal dynamics. 4. Better product solution for the direct replacement of the taper roller bearing.

In an embodiment of the present invention, the occurrence of slipping motion between the rolling elements (37, 62, 35, 63, 34, 36) of bearing (38, 40,42, 44) is lesser comparatively with bearings found in the art. the prior art bearings. The pure rolling motion of the tandem ball bearing (38, 40, 42) is also improved in comparison to existing tandem ball bearings. In another embodiment of the present invention, the configuration of the various elements of the tandem ball bearing (38, 40, 42, 44) of the present invention allows for the enhanced internal dynamics of the tandem ball bearing.

While considerable emphasis has been placed herein on the components and component parts of the various embodiments, it will be appreciated that many embodiments can be made and that many changes can be made in the embodiments without departing from the scope and spirit of the invention. These and other changes in the various embodiment of the disclosure will be apparent to those skilled in the art from the disclosure.

What is claimed is:

1. A tandem ball bearing comprising:
an outer ring;
an inner ring;
a plurality of outer balls disposed between the outer ring and the inner ring to form an outer ball row;
a plurality of inner balls disposed between the outer ring and the inner ring to form an inner ball row;
wherein the plurality of outer balls and the plurality of inner balls are configured such that a plurality of external tangent apex associated with the plurality of outer balls and the plurality inner balls meet at a common point on a bearing central axis.

2. The tandem ball bearing as claimed in claim 1, wherein the diameter of outer balls is greater than the diameter of inner balls.

3. The tandem ball bearing as claimed in claim 1, wherein the outer ball row has an outer pitch diameter and the inner ball row has an inner pitch diameter, and each of the plurality of outer balls has a diameter and each of the plurality of inner balls has a diameter, wherein the ratio of the outer pitch diameter to the inner pitch diameter is equal to ratio of the diameter of each of the plurality of outer balls to the diameter of each of the plurality of inner balls.

4. The tandem ball bearing as claimed in claim 1, wherein a contact angle α1 of the outer ball row is equal to a contact angle α2 of the inner ball row.

5. The tandem ball bearing as claimed in claim 1, wherein a difference between a contact angle α1 of the outer ball row and a contact angle α2 of the inner ball row is in a range between zero to five degrees.

6. The tandem ball bearing as claimed in claim 1, an outer ring;
an inner ring;
a plurality of outer balls disposed between the outer ring and the inner ring to form an outer ball row; and
a plurality of inner balls disposed between the outer ring and the inner ring to form an inner ball row therewith at positions, wherein the outer ball row has an outer pitch diameter and the inner ball row has an inner pitch diameter, and each of the plurality of outer balls has a diameter and each of the plurality of inner balls has a diameter,
wherein the ratio of the outer pitch diameter to the inner pitch diameter is equal to ratio of the diameter of each of the plurality of outer balls to the diameter of each of the plurality of inner balls.

7. The tandem ball bearing as claimed in claim 1, wherein the outer ball row has an outer pitch diameter 67 and the inner ball row has an inner pitch diameter, wherein the outer pitch diameter is more than the inner pitch diameter, the outer ball row is a ball row having more pitch diameter value compared to other ball row in a pair of ball rows in a tandem ball bearing.

8. The tandem ball bearing as claimed in claim 1, wherein the tandem ball bearing includes the outer ring with a minimum section outer ring, the inner ring with a minimum section inner ring, the minimum sectional value of outer ring is greater than or equal to 0.15 times of the outer ball diameter; and the minimum sectional value of inner ring is greater than or equal to 0.15 times of the inner ball diameter.
